(19) United States
(12) Patent Application Publication
(10) Pub. No.: US 2005/0228817 A1
(43) Pub. Date: Oct. 13, 2005

(54) Method, system, and software for electronic data capture and data analysis of clinical databases

(75) Inventors: Alan Hochberg, Harrisburg, PA (US); Jonathan Morris, La Jolla, CA (US); Stephanie Reisinger, Etters, PA (US)

Correspondence Address: FOLEY AND LARDNER;SUITE 500, 3000 K STREET NW, WASHINGTON, DC, 20007, US

(73) Assignee: ProSanos Corporation

(21) Appl. No.: 10/971,701

(22) Filed: Oct. 25, 2004

Related U.S. Application Data
(60) Provisional application No. 60/513,541, filed on Oct. 24, 2003.

(51) Int. Cl. G06F 17/30

(52) U.S. Cl. 707/102

(57) ABSTRACT

A method, system, and software for providing clinical data for analysis. purposes, includes storing clinical data, received from one or more data source sites, in a data repository. On receiving a request for data from the data repository from a user at a data source site, a working set of data is created responsive to the request from the user, and the user is provided access to the working set for analysis purposes. The working set of data is created such that at least some of the data in the working set is unchanged while the analysis is performed even if the data repository is updated while the analysis is performed, and working set only includes restricted data from other data source sites other than the data source site of the user.

### CROSS REFERENCE TO RELATED APPLICATION

This application claims priority to U.S. Provisional Application Ser. No. 60/513,541 filed on Oct. 24, 2003, the disclosure of which is incorporated herein in its entirety.

### BACKGROUND OF THE INVENTION

The present invention relates generally to an approach for improved access to and processing of data in clinical or other similar medical databases.

In a clinical trial, suitable databases containing valuable data are often not accessible for analysis purposes, until completion of the trial. Accordingly, valuable data collected and stored in these clinical databases are not used optimally during the clinical trial. Furthermore, even if the data stored in the clinical databases were available, conventional clinical-trial data management software packages, such as Clintrial™ from Phase Forward Inc. of Waltham, Mass., lack features that allow convenient analysis of the data stored in the clinical trial databases. Accordingly, there is a need for improved access to data in clinical trial or other similar clinical databases for analysis purposes.

### SUMMARY OF THE INVENTION

In certain embodiments, the present invention provides a computer implemented method of providing clinical data for analysis purposes, including: storing clinical data, received from one or more data source sites, in a data repository; receiving a request for data from the data repository from a user at a data source site; creating a working set of data responsive to the request from the user; and providing the user access to the working set for analysis purposes, wherein the working set of data is created such that at least some of the data in the working set is unchanged while the analysis is performed even if the data repository is updated while the analysis is performed, and wherein the working set only includes restricted data from other data source sites other than the data source site of the user.

In certain embodiments, the present invention provides a system for providing clinical data for analysis purposes, including: one or more data source sites that provide clinical data; and a data repository that receives and stores data received from the one or more data source sites. The data repository includes a working set management unit that creates a working set of data responsive to a request from a user at a data source site, and a user access management unit that determines which data could be included in a working set of data based on the user making the request and the data source site associated with the user. The working set management unit is configured to ensure that at least some of the data in the working set is unchanged while analysis is performed even if the data repository is updated while the analysis is performed, and the working set management unit receives input from the user access management unit to create the working set to only include restricted data from other data source sites other than the data source site associated with the user.

In certain embodiments, the present invention provides a computer readable medium having computer program code recorded thereon that, when executed on a computing system, provides clinical data for analysis purposes, the program code including: code for storing clinical data, received from one or more data source sites, in a data repository; code for receiving a request for data from the data repository from a user at a data source site; code for creating a working set of data responsive to the request from the user; and code for providing the user access to the working set for analysis purposes. The working set of data is created such that at least some of the data in the working set is unchanged while the analysis is performed even if the data repository is updated while the analysis is performed, and the working set only includes restricted data from other data source sites other than the data source site of the user.

### BRIEF DESCRIPTION OF THE DRAWINGS

FIG. 1 is a block diagram illustrating the system components in one embodiment of the present invention.

FIG. 2 is a diagram of a generic computing system connected to a network.

FIG. 3 is a flowchart illustrating the processing in one embodiment of the present invention.

### DETAILED DESCRIPTION OF THE VARIOUS EMBODIMENTS

In certain embodiments, the present invention provides for receiving data on patients undergoing treatment for a particular disease as part of normal clinical medical practice, to capture that data into a database, and to facilitate analysis of the data. Such a systematic collection of data regarding a particular disease is known as a “patient registry,” which is one example of a clinical database to which the principles of the present invention can be applied. Patient registries differ from clinical trial data collections, which are rigorously controlled and do not reflect normal clinical practice. One of the purposes of this invention is to overcome the limitations of conventional electronic data capture and analysis systems used with clinical databases, which have been developed for clinical trials and are not well adapted for data capture and analysis of data in patient registries. Another purpose of the present invention includes providing access to patient registry data from multiple sources in such a manner that the privacy of the data is maintained. Furthermore, access to the data is carefully restricted so that while any one party may have access to aggregate data from the multiple data sources it only has access to detailed data from any particular source if it has been granted explicit access rights to access that particular data source.

In certain embodiments, the system consists of one or more of the following components which are discussed in detail further herein: (1) a data repository computer system; (2) electronic data capture software; (3) edit check software and audit software; (4) data query software including (a) working set and (b) user access control features. Each of these components will be discussed in greater detail further herein.

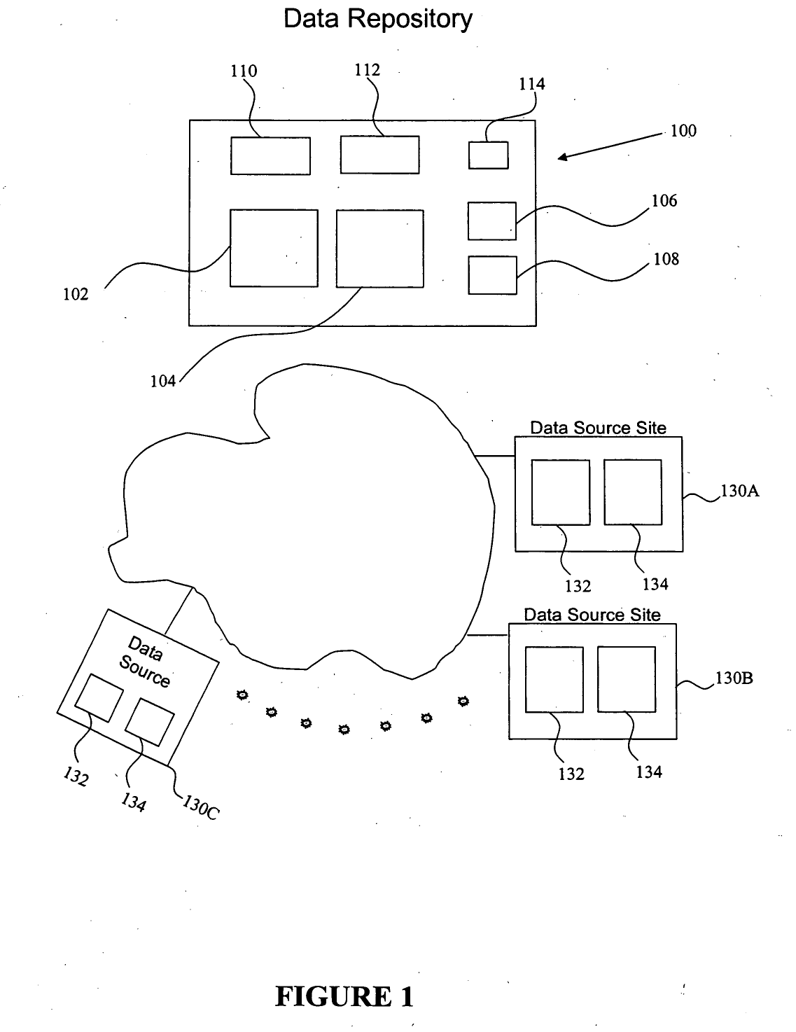

FIG. 1 is a block diagram illustrating the system components of one embodiment of the present invention. It should be recognized that FIG. 1 is exemplary only and one skilled in the art would recognize various modifications and alternatives, all of which are considered as a part of the present invention. A data repository computer system 100 is provided which communicates with one or more data source sites (130A, 130B, 130C and so on) through a public or private network 120 such as the Internet. One skilled in the art would recognize that the network 120 could be any private or public network or inter-network, such as the Internet, and also includes virtual private networks, local area networks (LANs), wide area networks (WANs), or metropolitan area networks (MANs).

Data Repository Computer System (“Data Repository”) 100

The data repository 100 includes a data-entry device such as a keyboard and display and a storage device capable of storing patient records in a number of databases, each containing a number of data fields. The storage device may include a main database 104 which stores the clinical data records that may be received from one or more of the data source sites 130A-C. The data repository 100 may also include a quarantine database 102 which temporarily stores received data until the data can be verified for updating the main database 104. The data repository 100 may also include a transaction database 110 which stores all the transactions related to the clinical data that is stored by the data repository 100. Examples of transactions stored in the transaction database include data about new patients (including identification and clinical data about the patient) or data that updates information related to existing patients in the main database (either their identification data and/or their clinical data). Therefore, the transaction database 110 may contain records with information about a new patient that includes the following exemplary information: name, address, care provider information, disease particulars, treatment particulars, and medication particulars. The transaction database record may also contain administrative data such as a date and time stamp of when that record was generated or received. It should be noted that the present description refers to the date and time stamp of a record as exemplary data defining temporal information about a record. One skilled in the art would recognize that only the date or some other measure of time, such as the week or month, may also be used as the temporal measure based on the specifics of the clinical data being tracked or analyzed.

The data repository 100 also contains a network connection to the Internet (or other similar network) so that it can communicate with other computers at a number of sites where data originates (i.e., the data source sites 130A-C, for example). The data repository 100 computer system may be run by the sponsor of the patient registry.

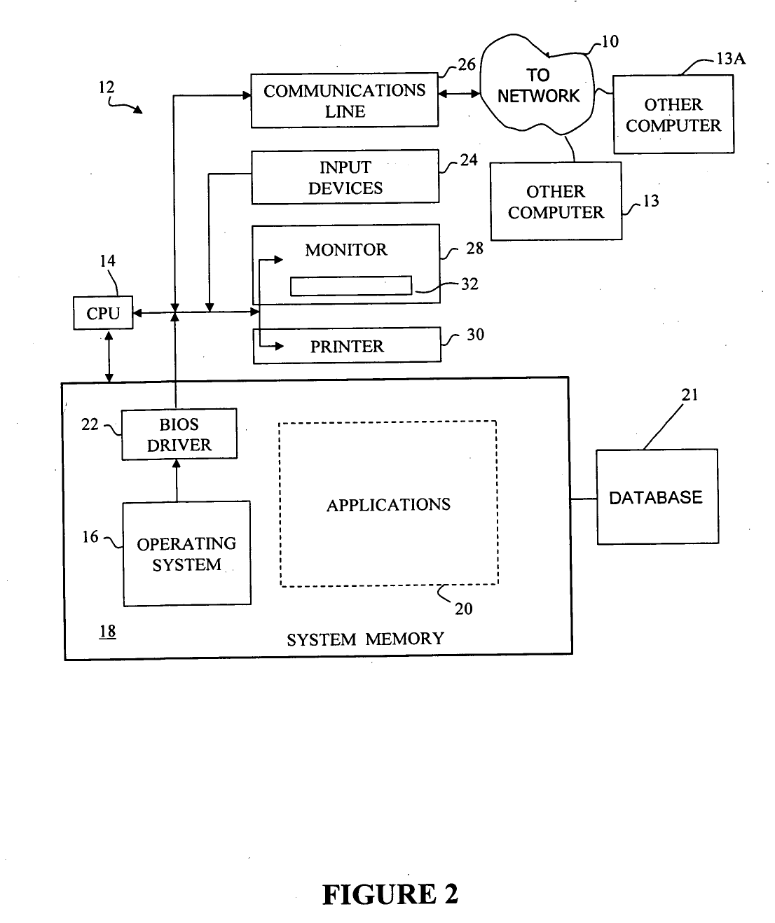

FIG. 2 illustrates the components of a generic computing system connected to a general purpose electronic network 10, such as a computer network. The computer network can be a virtual private network or a public network, such as the Internet. As shown in FIG. 1, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse or a keyboard 32, and output devices such as a printer 30 and a display monitor 28, and a permanent data store, such as a database 21. The computer system generally includes a communications interface 26, such as an ethernet card, to communicate to the electronic network 10. Other computer systems 13 and 13A also connect to the electronic network 10 which can be implemented as a Wide Area Network (WAN) or as an internetwork, such as the Internet. In certain embodiments, such a computer system 12 can be used to implement the computer system at the data repository 100 or at any one of the data source sites 130A-C.

One skilled in the art would recognize that the foregoing describes a typical computer system 12 connected to an electronic network 10. It should be appreciated that many other similar configurations are within the abilities of one skilled in the art and it is contemplated that all of these configurations could be used with the methods and systems of the present invention. Furthermore, it should be appreciated that it is within the abilities of one skilled in the art to program and configure a networked computer system to implement the method steps of certain embodiments of the present invention, discussed further herein.

In certain embodiments, the present invention also contemplates providing computer readable data storage means with program code recorded thereon (i.e., software) for implementing the method steps described further herein.

Electronic Data Capture Software

In certain embodiments, the system further includes electronic data capture software which accepts data entered by a user at a data-entry device (from paper forms or from transcription of a patient record), and stores the information in a quarantined database 102 or 132.. Such data capture software and quarantine database 102 or 132 may be provided in either of both of the data repository 100 or the data source sites 130A-C. For example, a quarantine database 102 may be provided at the data repository 100 while respective quarantine databases 132 may be provided at the data source sites 130A-C. Additionally, input data may be provided from other electronic sources or by flat files or may be updated in the databases in the data repository 100 by other means well known to those skilled in the art.

Edit Check and Audit Software

In certain embodiments, the system includes edit check software which prompts a user to change data which has been incorrectly entered, as determined by validation computations, for example. As specific examples, some of these edit checks could include checking for numbers which are out of range, or alphabetic entries where numbers are required and so on. In certain embodiments, the system includes audit software which allows a human or expert system auditor to approve data in the quarantined database (102 or 132), or to return that data to the originating user for corrections. The audit software also allows the auditor to periodically release data from the quarantine database (102 or 132) into a main database (104 or 134).

The electronic data capture software and audit software are protected from unauthorized access, for example, by password protection. In certain embodiments, the data capture software records who made each entry in the database, and when such entries were made, in a manner that is compliant with applicable regulations. For example, in the United States of America, 21 C.F.R. 11 describes regulations for electronic records and electronic signatures.

Data Query Software

In certain embodiments, the system provides data query software which allows users at the data source sites 130A-C to obtain relevant data from the main database 104 at the data repository 100. One skilled in the art would recognize that the main database 104 is logically defined. Physically, the main database 104 may consist of several databases that may be at one location or even located in a distributed arrangement provided that software and/or hardware logic is provided to access the main database in an integrated manner irrespective of the physical architecture or arrangement of the physical database(s) that may make up the main database 104. One skilled in the art would also recognize that the data query process could be organized such that a user associated with a data source site 130A-C may directly access the data repository 100 using a virtual terminal or otherwise. However, the data repository 100 would associate such a user with the appropriate data source site 130A-C and provide access to the same data to that user as if that user has accessed the data repository from the appropriate data source site 130A-C associated with that user.

Working Sets

In certain embodiments, the data query software has the following features. At the time when the user (for example, an analyst or researcher) begins an analysis session a data source site 130A-C which communicates with the data repository 100, data is extracted from the main database 104, and placed into a working set, which can be visualized and statistically analyzed by the user.

In certain embodiments, the working set that is created is associated with the user (or a group of users) and is maintained for the user by that user (or that group of users). The use of a working set prevents the user's data from changing if any updates to the main database 104 take place during the analysis session. This is significant because it would be unacceptable for the user to, say, produce one table for publication with 871 total patients, and then produce a subsequent table in the same article with 930 patients, because an update to the main database 104 had taken place. Furthermore, in certain embodiment, the user can permanently store a working set for archival purposes. The user can decide when to end the analysis session, allowing him/her to receive updated data with respect to the working set that has been created for the user.

In certain embodiment, the working set may include a set of records for which some data fields may continue to be updated while others may not. For example, the total number of records may not be changed although some of the fields of the data records may continue to be updated. Therefore, the above example, the user may create a working set with 871 patient records and then get updates to some of the data fields of these 871 patient records while the remaining data fields and number of the patient records are not changed.

Therefore, when an analysis session begins, in certain embodiments, the system defines a “working set” of data which remains fixed during the entire session, so that all analyses performed during that session are consistent with one another, in terms of the population of patients being analyzed, and the particular data regarding those patients.

In certain embodiments, one method for creating such a working set would be to extract the appropriate data from the main database, and copy it into a separate file or database (or database table(s)), for example, the actual working set database 114 show in FIG. 1. The data in the actual working set database 114 is then used as the working set. This might be called a “physical working set” approach, since a new file or database (or database table(s)) is physically created in the actual working set database 114. While this approach has the advantage of simplicity, it has the the disadvantage of requiring large amounts of computer storage space. It could effectively require a copy of the database (or a significant subset thereof) for every analysis session ever conducted by any user. Furthermore, these copies would need to be retained as an archive so that the results of a given analysis session could be recreated at a later time.

In certain embodiments, another approach is used that involves the creation of what might be called a “virtual working set.” In this approach, each transaction which creates, modifies, or removes a record in the main database 104 is tagged with a date and time stamp. These transaction records are stored in a transaction database 110, for example, with the date and time stamp as a key. The transaction database 110 may be implemented in a commercially available relational database. When an analysis session begins, that action defines a range of date and stamps which in turn reference the data in the transaction database 110 and/or the main database 104, through a “relation” as the term is understood in the database art. To create and maintain working sets for many users the information that is stored is: 1) the transaction records in a transaction database 110, including their time and date stamps as a key; and 2) a record or archive of the starting and ending date and time of each analysis session. This record or archive of the starting and ending date and time of each analysis session is stored in a database 112 (which is a virtual working set database). The database of transaction records (110) is potentially quite large, but only one copy need ever be stored. That one copy would cover all analysis sessions and all users. The virtual working set database (112) is quite small, and could easily be stored for each user and each analysis session without unduly taxing a storage device. Thus the “virtual working set” would be an implementation of the working sets where the virtual working set database stores information of each user or analysis session. This arrangement provides efficient usage of storage when there are a large number of users and analysis sessions since the data for each user analysis session is relatively small.

In certain embodiments, the working set management unit 106 determines the number of records to include for a request from a data source site 130A based on the number of records provided by that data source site 130A. Therefore, the working set management unit 106 keeps track of the number of records provided by each data source site. The number of records in from other data source sites included in a working set created in response to a request from a particular data source site is proportional or related to the number of records provided by that particular data source site. Therefore, in one example, as the number of records contributed by a data source site increases, the number of records from other data source site included in the working set provided to that data source site is also proportionately increased. In another example, the data source sites could be categorized into categories based on the number of records provided by the respective data source sites and all the data source sites in one category are provided working set's that include the same number of records from other data source sites.

User Access Control

In certain embodiments, the system is designed with an architecture where the analysis sessions are run from different data source sites 130A-C, and the sites 130A-C are notified when the main database 104 has been updated. At each update, the sites 130A-C are informed how many patients have been added from their own site, and how many total patients have been added to the main database 104.

In certain embodiments, queries originating at a particular site 130A-C may access data from that site in sufficient detail to identify individual patients. The database records and fields that are accessible to a site 130A-C are configured by the sponsor of the data repository 100, and stored in an access rights table at the data repository as the site's own data access privileges. The data repository 100 includes a user access management unit 108 which reads the access rights table to ensure that a user from a data source site 130A-C can only access data that the user is authorized to access based on the identity of the user and/or the data source site 130A-C associated with that user. Of course, a user may be associated with more than one data source site 130A-C and this information is also stored at the access rights table and is used by the user access management unit 108 Queries originating at a particular data source site 130A-C or from users associated with a particular data source site (for example, 130A) may furthermore have restricted access to data from other data source sites and generally the restricted access would not provide data with sufficient detail to identify individual patients.

As discussed herein, in certain embodiments, the access control also could be implemented at a user level rather than at a site level. For example, a user would have access to all details of records associated with that user while only having aggregate level access to all (or some subset) of the other records associated with the other users.

In certain embodiments, the restricted access to data from other sites and/or users is provided by suppressing certain data fields from display or access. For example, the identification information of a patient may be removed when providing a data record of that patient. In another embodiment, details may be further hidden by having the data repository 100 not comply with queries that would return a set of patient records smaller than a predetermined size, typically 5-10. In a further embodiment, if the data repository is queried to return a result set smaller than the predetermined size, it only returns an average value for each data field for the data records in the result set rather than the individual data records.

This number or size could be determined by one skilled in the art based on the particular data stored in the database and it is generally accepted that sets smaller than the 5-10 records, for example, may be used to identify individuals in patient registries or other similar clinical databases. Therefore, the system provides that the list of accessible database records and fields, and the minimum size of a query response, are configured by the sponsor, and stored in the access rights table where it is used by the user access management unit of the data repository 100. The rules used by the user access management unit 108 (typically implemented as software) to control access also could be embedded in the access logic, or other means could be provided to implement the access control so that particular data records and fields are not accessible and that a data access query does not return a result set having fewer than a configurable predetermined minimum number of data records.

In certain embodiments, queries from the sponsor of the data repository 100 may access any portion of the main database 104.

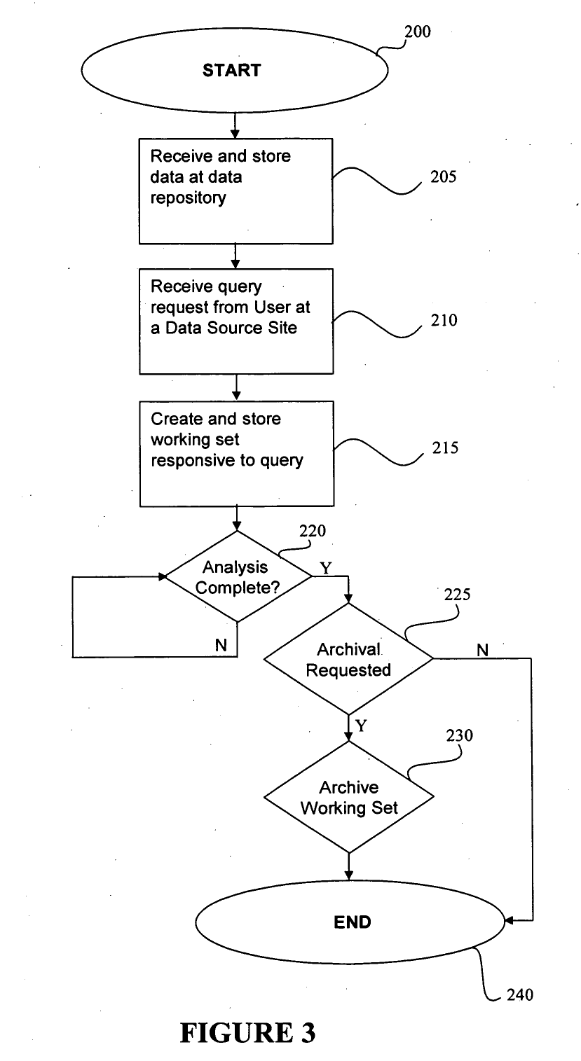

FIG. 3 is a flowchart that illustrates the process flow of providing access to clinical data in certain embodiments of the present invention. In step 205, the data repository 100 receives and stores data received from the data source sites 130A-C. In addition to storing the clinical data that is received from the data source sites 130A-C, the data repository stores an indication of the site that is the source of the data so that access to the data can be controlled. In addition, the user access management unit 108 of the data repository 100 stores access control information based on the users who are allowed to access the data as well as the data source sites 130A-C associated with the users.

In step 210, the data repository 100 receives a query request from a user at a data repository site. Once the user access management unit 108 verifies the access rights of the user making the request, the working set management unit 106 creates a working set of data in step 215 responsive to the request and provides the user access to the working set. As discussed earlier herein, the creation of the working set of data could be performed by physically copying selected (and optionally modified or restricted) data records from the main database 104 to an actual working set database 114 or by storing working set related data in a virtual working set database 112 together with transaction data in a transaction database 110 so that the working set is created as required (as a “virtual” working set rather than a working set physically stored permanently or semi-permanently in a separate database).

In step 220, the system checks to see whether the analysis is complete, for example, based on an indication provided by the user. If so, in step 225, the system checks to see if the user has requested archival of the working set data, and if so, in step 230, the system arranges to archive the working set. For example, in certain embodiments, the data corresponding to this working set in the actual working set database 114 can be flagged to avoid deletion. Likewise, the working set related data in the transaction database 110 and/or the virtual working set database 112 can also be flagged to avoid deletion in the virtual working set approach. The process concludes in step 240 after the archival is completed.

Some of the Advantages and Features of System

Some of the features of the system provided include: (1) data capture in a main database including associating data with sites and/or users (or user groups); (2) dynamic management of working sets derived from a main database, and (3) management of access rights for individual sites or users (or user groups) within a global data-collection system. The dynamic management of working sets may include creating separate data sets for each working set. The dynamic management of working sets may include creating and maintaining a transaction database with date/time stamps for all transactions that access, create, modify, or delete any records in the main database together with a working set database which records the starting and ending date/time stamp for each working set whereby the working set is virtually created by referencing the transaction database and the working set database. The management of access rights includes restrictions on data records and fields that may be accessed by sites or users (or user groups). The management of access rights may allow a site or user (or user group) access to details of all records for that site or user (or user group) while providing restricted access to records pertaining to other sites or users (or user groups), for example, by providing access only to aggregate information based on the records rather than to the data in the individual records themselves. The management of access rights may also restrict query access to detail records if the result set responsive to the query is smaller than a certain size.

As used in this application, the term “patients” denotes animals, including humans, or plants that may be subject to treatable diseases.

Other embodiments of the invention will be apparent to those skilled in the art from a consideration of the specification and the practice of the invention disclosed herein. It is intended that the specification be considered as exemplary only, with such other embodiments also being considered as a part of the invention in light of the specification and the features of the invention disclosed herein. Furthermore, it should be recognized that the present invention includes the methods disclosed herein together with the software and systems used to implement the methods disclosed here.

1. A computer implemented method of providing clinical data for analysis purposes, comprising:
storing clinical data, received from one or more data source sites, in a data repository;
receiving a request for data from the data repository from a user at a data source site;
creating a working set of data responsive to the request from the user; and
providing the user access to the working set for analysis purposes,
wherein the working set of data is created such that at least some of the data in the working set is unchanged while the analysis is performed even if the data repository is updated while the analysis is performed, and
wherein the working set only includes restricted data from other data source sites other than the data source site of the user.

2. The computer implemented method according to claim 1, wherein the step of storing the clinical data comprises storing the data in a quarantine database and updating a main database from the quarantine database after a review of the data in the quarantine database.

3. The computer implemented method according to claim 1, wherein the step of storing the clinical data comprises edit checks on data entered from a terminal or received from an external source, and updating access control information related to any data received from a data source site.

4. The computer implemented method according to claim 1, wherein the step of creating a working set of data comprises copying records from the main database to a working set database.

5. The computer implemented method according to claim 1, wherein the step of creating a working set comprises maintaining a transaction database that includes a date and time stamp for each transaction and a working set date and time stamp database that includes the start and/or end date and time stamp for each working set.

6. The computer implemented method according to claim 1, wherein the step of providing the user access to the working set comprises providing access to detail records only from the data source site associated with user while providing restricted access to data from any other data source site.

7. The computer implemented method according to claim 6, wherein the restricted access comprises removing fields from each data record provided to the user.

8. The computer implemented method according to claim 6, wherein the restricted access comprises providing aggregate data derived from aggregating individual data records rather than providing individual data records themselves.

9. The computer implemented method according to claim 6, wherein the restricted access further comprises not providing any individual data record information if the number of individual data records is less than a predetermined number.

10. The computer implemented method according to claim 1, wherein the number of records from other data source sites included in the working set is related to the number of data records provided by the data source site to the data repository.

11. The computer implemented method according to claim 10, wherein the number of records from other data source sites included in the working set is directly proportional to the number of data records provided by the data source to the data repository.

12. A system for providing clinical data for analysis purposes, comprising:
one or more data source sites that provide clinical data;
a data repository that receives and stores data received from the one or more data source sites; and
said data repository comprising:
a working set management unit that creates a working set of data responsive to a request from a user at a data source site; and
a user access management unit that determines which data could be included in a working set of data based on the user making the request and the data source site associated with the user;
wherein the working set management unit is configured to ensure that at least some of the data in the working set is unchanged while analysis is performed even if the data repository is updated while the analysis is performed, and
wherein the working set management unit receives input from the user access management unit to create the working set to only include restricted data from other data source sites other than the data source site associated with the user.

13. The system according to claim 11, wherein the data repository further comprises:
a main database to store data received from each of the data source sites; and
actual working set database that contains the data records for each working set copied from the main database.

14. The system according to claim 12, wherein the data repository further comprises:
a transaction database that contains all transaction records, the transaction records including a date and time stamp of the transaction;
a virtual working set database which comprises a start and/or an end date and time stamp for each working set,
wherein the working set management unit creates the data for a working set with reference to the start and/or end date and time stamps for that working set and retrieving transaction records from the transaction database based on a comparison of the date and time stamps of the transactions to the start and/or the end date and time stamps of the working set.

15. The system according to claim 13, wherein the data repository further comprises a quarantine database that temporarily stores data records received from data source sites before they are updated on the main database after being reviewed.

16. The system according to claim 12, wherein the user access management unit only allows a user access to detail records originating from the data source site associated with the user while allowing the user restricted access to data originating from other data source sites.

17. The system according to claim 16, wherein the user access management unit allows restricted access to data by removing certain fields from each data record that may be included in a working set.

18. The system according to according to claim 16, wherein the user access management unit allows restricted access to data by only allowing access to aggregate data derived by aggregating individual data records rather than allowing access to the individual data records themselves.

19. The system according to claim 16, wherein the user access management unit allows restricted access to data by not providing any individual data record information if the number of individual data records in less than a predetermined number.

20. A computer readable medium having computer program code recorded thereon that, when executed on a computing system, provides clinical data for analysis purposes, the program code comprising:
code for storing clinical data, received from one or more data source sites, in a data repository;
code for receiving a request for data from the data repository from a user at a data source site;
code for creating a working set of data responsive to the request from the user; and
code for providing the user access to the working set for analysis purposes,
wherein the working set of data is created such that at least some of the data in the working set is unchanged while the analysis is performed even if the data repository is updated while the analysis is performed, and
wherein the working set only includes restricted data from other data source sites other than the data source site of the user.

21. The computer readable medium according to claim 20, code for creating a working set of data comprises code for copying records from a main database to working set database.

22. The computer readable medium according to claim 20, wherein the code for creating a working set of data comprises code for updating a transaction database that includes a date and time stamp for each transaction and code for updating a working set database with a start and/or end date and time stamp for each working set.

23. A method of analyzing data from a clinical database comprising:
sending data from a data source site to a data repository for storage at the data storage site;
sending a request for data by a user at the data source site to the data repository; and
receiving access to a working set of data responsive to the request for data, wherein the data repository creates the working set of data such that at least some of the data in the working set is unchanged while the analysis is performed even if the data repository is updated and wherein the working set only includes restricted data from data source sites other than the data source site of the user.
